(19) United States
(12) Patent Application Publication
(10) Pub. No.: US 2014/0249769 A1
(43) Pub. Date: Sep. 4, 2014

(54) PAPER MONEY DETECTION AND COUNTING DEVICE AND DETECTION AND COUNTING METHOD

(71) Applicant: GRG BANKING EQUIPMENT CO., LTD., Guangzhou, Guangdong (CN)

(72) Inventor: Junqing Liao, Guangzhou (CN)

(21) Appl. No.: 14/348,325

(22) PCT Filed: Mar. 26, 2013
(86) PCT No.: PCT/CN2013/073170

§ 371 Date: Mar. 28, 2014

(30) Foreign Application Priority Data
Jun. 4, 2012 (CN) 201210181661.X

(51) Int. Cl. G06M 11/00

(52) U.S. Cl. CPC G06M 11/00
USPC 702/128

(57) ABSTRACT

A paper money detection and counting device comprises: a sensor unit which is used for converting the output signals of a plurality of sensors distributed on a paper money transmission passage into a transmission state which characterizes whether paper money is present or not, each sensor corresponding to a paper money counter; a calculation unit which calculates the paper money distance between the current detection position of any sensor and the front end position of the currently detected paper money according to the transmission state output by the sensor unit; and a control unit, once the paper money distance calculated by the calculation unit goes beyond a paper money spacing standard value, the control unit looking up the transmission states output accumulatively by the sensors currently, when it is found that at least one transmission state characterizes that the paper money state changes from existence to nonexistence, adding 1 to the count value of the paper money counter corresponding to the sensor, and when it is found that at least one transmission state characterizes that the paper money state changes from nonexistence to existence, judging that the current paper money detection is completed, and sending to the calculation unit the position where the paper money distance from the front end of the currently detected paper money is closest to the paper money spacing standard value, as the front end position of the next detected paper money, so as to enable the calculation unit to use the front end position of the next detected paper money as an initial position to calculate the distance of the next paper money.

This application claims priority of Chinese patent application No. 201210181661.X, entitled “PAPER MONEY DETECTION AND COUNTING DEVICE AND DETECTION AND COUNTING METHOD” and filed with the State Intellectual Property Office on Jun. 4, 2012, which is incorporated herein by reference in its entirety.

### FIELD OF THE INVENTION

The invention relates to the field of financial technology, and in particular to a device and method for detecting and counting banknote-like objects, which is applicable to an Automated Teller Machine (ATM) for anti-interference detection on partly broken banknotes or banknotes with holes.

### BACKGROUND OF THE INVENTION

Light sensors are usually used in ATMs for detecting transmission states of banknotes in a passage. When multiple banknotes pass through the light sensor sequentially, multiple transmission states each representing presence or non-presence of each of the banknotes will be generated.

In a typical method for detecting banknotes, when the sensor outputs a transmission state representing a transition from non-presence of a banknote to presence of a banknote, it is determined that the front end of the current banknote is detected, and the detection of the current banknote is started; or when the sensor outputs a transmission state representing a transition from presence of a banknote to non-presence of a banknote, it is determined that the back end of the current banknote is detected, and the detection of the next banknote is started; or the above two ways may be used together. By using the method of detecting the transmission states, banknotes can be distinguished and counted in accordance with the detection sequence.

However, in a case that the signal representing the presence or non-presence of the banknote is interfered, especially in a case that a banknote with a hole is detected, following problems as shown in FIG. 1 will occur.

1. Due to installation locations, not all of the light sensors can detect the hole 101 of the banknote 100. Therefore, intervals (which may be time intervals or distance intervals) from non-presence to presence states or from presence to non-presence states outputted from different light sensors (for example, the first sensor 201 and the second sensor 202) are different.

2. Due to the hole 101, the sensor (for example, the first sensor 201) may count the banknotes inaccurately.

In a case that the banknote processing device in the ATM detects the above to abnormal transmission, one of the following processes may be performed:

a, return the banknote causing the abnormal transmission to a cash input/output port;

b, store the banknote causing the abnormal transmission into a recycling box; and

c, stop the current operation, resume the ATM and restart a new service.

No matter which of the above processes is used, the efficiency of the ATM is decreased, and thereby the service performance of the ATM for the user is decreased.

During the circulation, the banknote becomes worse and is unavoidably to be broken. In addition, banknotes of certain countries have holes on themselves as features. For example, some countries of Southeast Asia use plastic banknotes with features of transparent holes. If banknotes having the holes or broken banknotes are transmitted in the passage, wrong determinations may be made by using the existing banknote processing device for detecting and counting, thereby the efficiency of the ATM is decreased. Therefore, it is desired a more reliable method and device for detecting and counting banknotes being transmitted.

### SUMMARY OF THE INVENTION

A device and a method for detecting and counting banknote-like objects are provided by embodiments of the present invention, which can eliminate interferences produced by broken banknotes and especially by banknotes with transparent holes, increase accuracy of banknote counting, and reduce wrong determination probability.

A device for detecting and counting banknote-like objects is provided by an embodiment of the present invention, including:

a sensor unit, adapted to convert output signals of a plurality of sensors distributed on a banknote transmission passage into transmission states each representing presence or non-presence of a banknote, where each of the plurality of sensors corresponds to a banknote counter;

a calculating unit, adapted to calculate, for any of the plurality of sensors, a banknote distance between a current detecting position and a front position of a current detected banknote according to the transmission states outputted from the sensor unit;

a control unit, adapted to, once the banknote distance calculated by the calculating unit exceeds a banknote interval reference, search the transmission states previously outputted with respect to the sensor, and

if at least one transmission state representing a transition from presence of a banknote to non-presence of a banknote is found, add 1 to a count value of a banknote counter corresponding to the sensor;

if at least one transmission state representing a transition from non-presence of a banknote to presence of a banknote is found, determine that detection of the current banknote is finished and send a detecting position representing the transition from non-presence of a banknote to presence of a banknote and having a distance from the front position of the current detected banknote that is the closest to the banknote interval reference, as a front position of a next detected banknote, to the calculating unit, so that the calculating unit uses the front position of the next detected banknote as an initial position for calculating a next banknote distance.

In addition, a method for detecting and counting banknote-like objects is correspondingly provided by an embodiment of the present invention, including steps of:

A1, converting output signals of a plurality of sensors distributed on a banknote transmission passage into transmission states each representing presence or non-presence of a banknote;

A2, calculating, for any of the plurality of sensor, a banknote distance between a current detecting position and a front position of a current detected banknote according to the transmission states outputted from a sensor unit;

A3, once the calculated banknote distance exceeds a banknote interval reference, searching the transmission states previously outputted, and if at least one transmission state representing a transition from presence of a banknote to non-presence of a banknote is found, adding 1 to a count value of a banknote counter corresponding to the sensor;

A4, once the calculated banknote distance exceeds the banknote interval reference, searching the transmission states previously outputted, and if at least one transmission state to representing a transition from non-presence of a banknote to presence of a banknote is found, determining that detection of the current banknote is finished and using a detecting position representing the transition from non-presence of a banknote to presence of a banknote and having a distance from the front position of the current detected banknote that is the closest to the banknote interval reference, as a front position of a next detected banknote for calculating a next banknote distance.

According to the embodiments of the present invention, there have following advantages. The device and method for detecting and counting banknote-like objects provided by the embodiments of the present invention are especially applicable to an Automated Teller Machine (ATM) for anti-interference detection on partly broken banknotes or banknotes with holes. Specifically, the counting of the banknotes with respect to each of the various sensors is performed according to a comparison result between a calculated banknote distance and a reference, but not performed by simply detecting the transmission state representing a transition from non-presence to presence or from presence to non-presence. Therefore, there will be no miscounting when interference (for example, a banknote with a hole) appears. Meanwhile, an abnormal transmission of banknotes is determined by determining whether banknote intervals of adjacent sensors are consistent, so the probability of wrong determination is reduced when interference appears. Therefore, according to the device and method for detecting and counting banknotes provided by the embodiments of the present invention, the accuracy of banknote counting is increased and the probability of wrong determinations is reduced.

### BRIEF DESCRIPTION OF THE DRAWINGS

FIG. 1 is a schematic diagram illustrating that a detecting process of a method for detecting and counting banknote-like objects in the prior art is affected by a banknote with a hole.

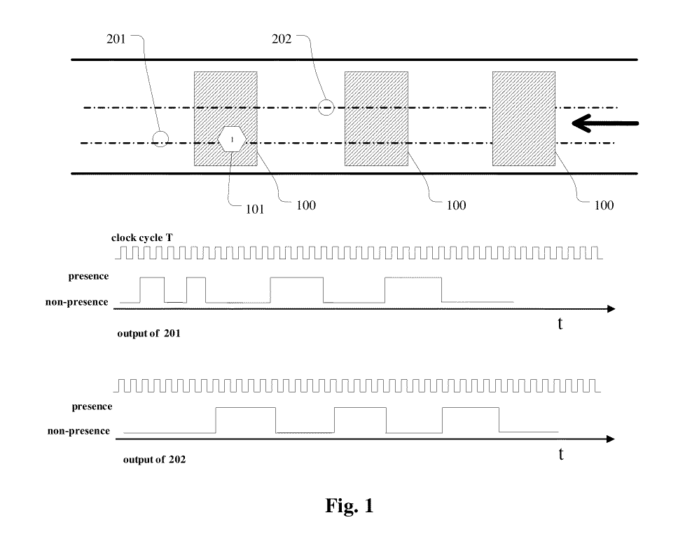

FIG. 2 is a structure diagram illustrating a device for detecting and counting banknote-like objects according to the present invention.

FIGS. 3a-3c are schematic diagrams of locating a front position of a banknote by to using the device for detecting and counting banknote-like objects shown in FIG. 2.

FIG. 4 is a schematic structure diagram of a banknote-pickup mechanism in the prior art.

FIG. 5 is a flowchart of processes of the device for detecting and counting banknote-like objects shown in FIG. 2.

FIG. 6 is a flowchart of processes of a calculating unit of the device for detecting and counting banknote-like objects in FIG. 5.

FIG. 7 is a flowchart of processes of a control unit of the device for detecting and counting banknote-like objects in FIG. 5.

FIG. 8 is a flowchart of processes of a record and storage unit of the device for detecting and counting banknote-like objects in FIG. 5.

FIG. 9 is a flowchart of processing a banknote with a hole by using a method for detecting and counting banknote-like objects provided by an embodiment of the present invention.

FIG. 10 is a flowchart of a method for detecting and counting banknote-like objects according to the present invention.

### DETAILED DESCRIPTION OF THE INVENTION

Technical solutions of embodiments of the present invention will be described clearly and completely in conjunction with drawings of embodiments of the present invention. Obviously, the embodiments to be described are merely part but not all of embodiments of the present invention. Based on the embodiments described in the present invention, all of other embodiments obtained by those skilled in the art without any creative work fall within the protection scope of the present invention.

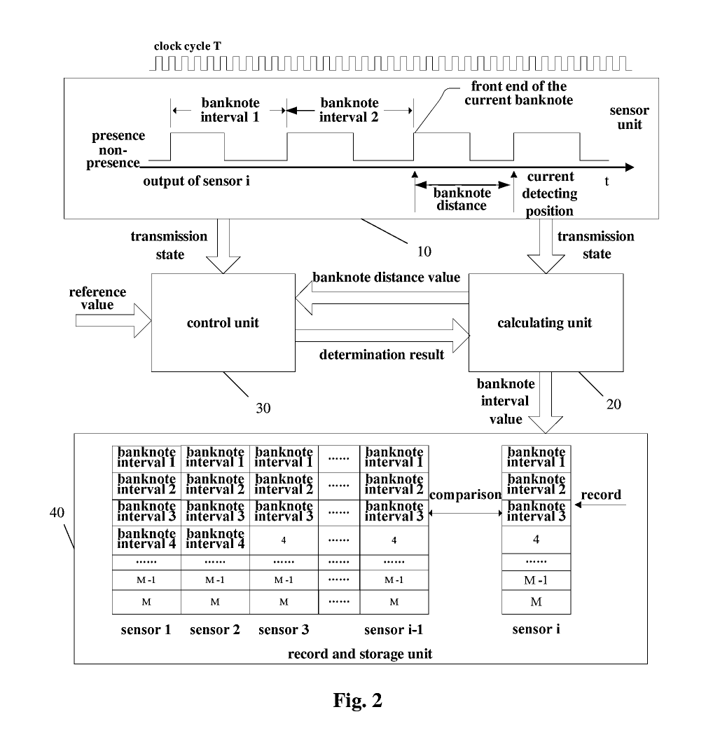

Referring to FIG. 2, a device for detecting and counting banknote-like objects of the present invention includes a sensor unit 10, a calculating unit 20, a control unit 30 and a record and storage unit 40.

The sensor unit 10 is adapted to convert, in accordance with a fixed clock cycle, output signals of a plurality of sensors distributed on a banknote transmission passage into to transmission states each representing presence or non-presence of a banknote, where each of the plurality of sensors corresponds to a banknote counter.

The calculating unit 20 is adapted to calculate, for any of the plurality of sensors, a banknote distance between a current detecting position and a front position of a current detected banknote; calculate an interval (which is refer to as a banknote interval) between the front position of the current banknote and a front position of a next banknote when the control unit 30 determines that detection of the current banknote is finished; and use the front position of the next banknote found by the control unit as an initial position for calculating a next banknote distance.

The control unit 30 is adapted to, once the banknote distance calculated by the calculating unit exceeds a banknote interval reference, search the transmission states previously outputted from the sensor unit, and

if at least one transmission state representing a transition from presence of a banknote to non-presence of a banknote is found, add 1 to a count value of a banknote counter corresponding to the sensor;

if at least one transmission state representing a transition from non-presence of a banknote to presence of a banknote is found, determine that detection of the current banknote is finished and send a detecting position representing the transition from non-presence of a banknote to presence of a banknote and having a distance from the front position of the current detected banknote that is the closest to the banknote interval reference, as the front position of the next detected banknote, to the calculating unit, so that the calculating unit uses the front position of the next detected banknote as an initial position for calculating a next banknote distance.

The record and storage unit 40 is adapted to obtain the banknote interval between the front position of the current detected banknote and the front position of the next detected banknote calculated by the calculating unit, store the banknote interval sequentially, compare the banknote interval with a recorded banknote interval with respect to a previous sensor, and if they are not consistent, send a signal for stopping detection of the banknotes.

Specific structures and principles of the device for detecting and counting to banknote-like objects of the present invention will be further described below in conjunction with FIGS. 2-5.

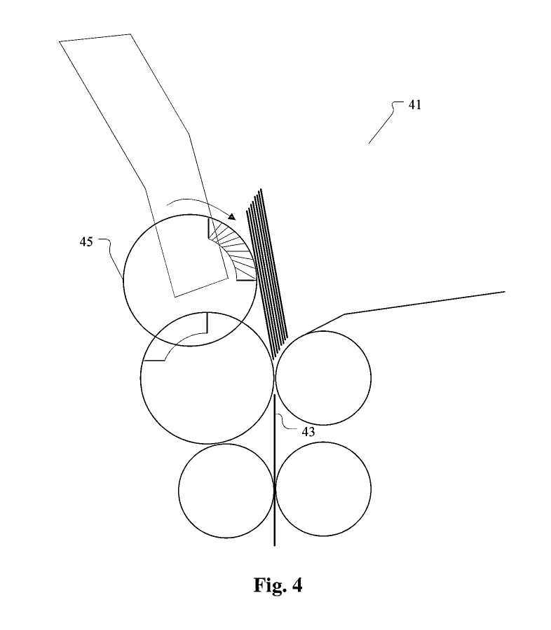

During ATM's services for inputting and outputting banknotes, a banknote-pickup mechanism 41 as shown in FIG. 4 is generally used to send a banknote 43 in a banknote repository into a transmission passage. Such banknote-pickup mechanism can theoretically ensure that one banknote is sent into the passage each time a banknote-pickup wheel 45 rotates one circle. Accordingly, in theory, the banknote interval between two adjacent banknotes is only related to the diameter D of the banknote-pickup wheel 45, rather than a banknote length. Therefore, the reference S_{ref} may be determined by S_{ref}=kπD, where k is a fixed value and denotes a transmission coefficient indicating a ratio of a transmission rate to a pick-up rate of a banknote in the passage, and πD denotes the perimeter of the banknote-pickup wheel 45.

As mentioned above, the front position of the banknote is needed for calculating the banknote distance (the time interval or the distance interval between the front position of the current detected banknote and the current detecting position of any of the sensors) or the banknote interval (the time interval or the distance interval between front ends of two adjacent banknotes), therefore how to detect and determine the front position of the banknote needs to be considered firstly.

There are two cases in detecting the front position of the banknote: if a banknote detected currently by any of the sensors is the first banknote passing through the sensor, a position corresponding to the transmission state representing a transition from non-presence of a banknote to presence of a banknote outputted from the sensor for the first time is determined as the front position of the first banknote;

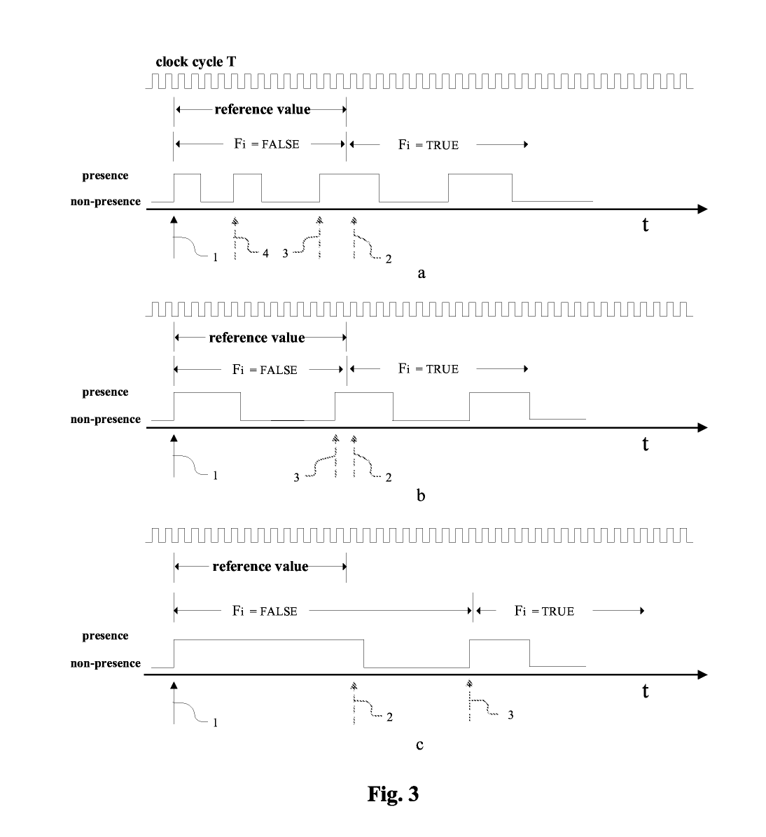

if the banknote passing through the sensor is not the first banknote passing through the sensor (that is, the next banknote), as shown in FIG. 3, in a case that the distance between the current detecting position (position 2 shown by a dashed line with arrow in the figure) and the front position of a previous banknote (position 1 shown by a solid line with arrow in the figure) is greater than a comparison value, the control unit searches for a to position meeting the following conditions between the position 2 and the position 1 as the front position of the next banknote:

condition i: the position indicates a transition from non-presence of a banknote to presence of a banknote; and

condition ii: the position has an interval from the position 1 that is the closest to the banknote interval reference.

FIGS. 3a, 3b and 3c show respectively three possible cases when the distance between the position 2 and the position 1 is greater than the comparison value, including:

as shown in FIG. 3a, there are multiple positions between the position 1 and the position 2 that meet condition i (position 3 and position 4 shown by a dashed line with arrow in the figure), but only position 3 meets condition ii;

as shown in FIG. 3b, there is only one position between the position 1 and the position 2 that meets condition i (position 3 shown by a dashed line with arrow in the figure);

as shown in FIG. 3c, there is no position between the position 1 and the position 2 that meets condition i.

In the case shown in FIG. 3c, a front position of a banknote cannot be found until a transmission state representing a transition from non-presence of a banknote to presence of a banknote appears. A front position of a banknote can be found according to condition i and condition ii in any of the cases. After the front position of the banknote is located, the front position of the banknote will be sent to the calculating unit as a front position of a detected banknote for calculating the next banknote distance value.

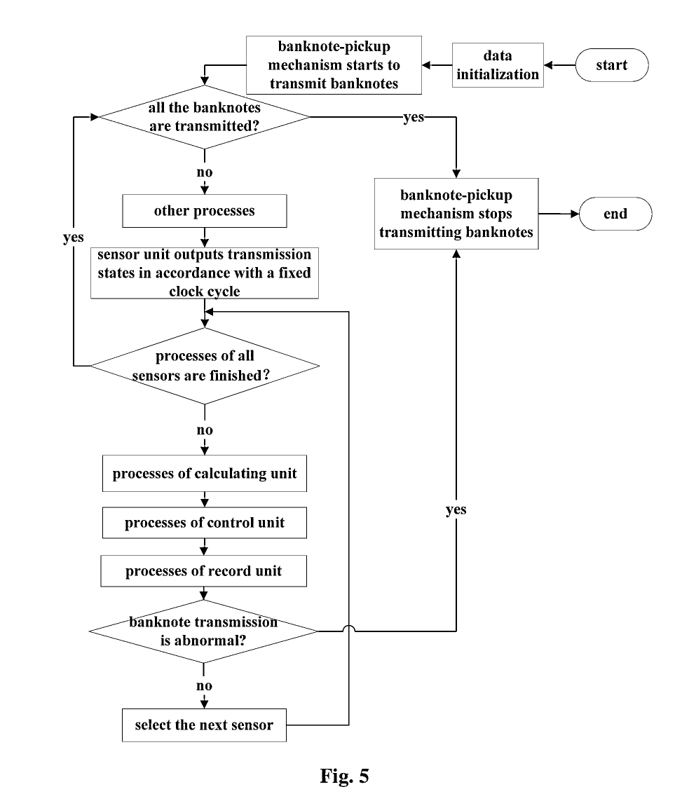

Referring to FIGS. 2 and 5, at the beginning of a service, the banknote-pickup mechanism 41 firstly separates gathered banknotes, and sends the banknotes into the banknote transmission passage one by one. When the banknotes sequentially pass through sensors distributed on the transmission passage, each sensor outputs a corresponding signal and sends the corresponding signal to the sensor unit 10 of the device for detecting and counting banknotes of the present invention. The sensor unit 10 converts the signals outputted from each of the sensors into transmission states each representing presence or non-presence of a banknote in accordance with a fixed clock cycle provided by a clock unit, and sends the transmission states to the control unit 30 and the calculating unit 20 for processing.

The calculating unit 20 and the control unit 30 process the transmission states of each of the sensors sequentially.

The calculating unit 20 firstly calculates, for any of the sensors, a banknote distance between a front position of a current detected banknote and a current detecting position according to the transmission states outputted from the sensor unit 10.

The control unit 30 then compares the result calculated by the calculating unit 20 with a banknote interval reference. If the banknote distance value exceeds the banknote interval reference, the control unit searches the transmission states previously outputted with respect to the sensor for a back position of the current banknote (that is, a transition from presence to non-presence), and adds 1 to the count value of the banknote counter corresponding to the sensor when at least one transmission state representing a transition from presence of a banknote to non-presence of a banknote is found. Meanwhile, the control unit also searches for the front position of the next banknote (that is a transition from non-presence to presence), determines that detection of the current banknote is finished when at least one transmission state representing a transition from non-presence of a banknote to presence of a banknote is found, and sends a detecting position representing the transition from non-presence of a banknote to presence of a banknote and having a distance from the front position of the current detected banknote that is the closest to the banknote interval reference, as the front position of the next detected banknote, to the calculating unit, so that the calculating unit 20 uses the front position of the next detected banknote as an initial position for calculating the next banknote distance.

If the control unit 30 determines that detection of the current banknote passing through the sensor is finished, the calculating unit 20 calculates the banknote interval between the front position of the current detected banknote and the front position of the next detected banknote, and sends the banknote interval to the record and storage unit 40. The record and storage unit 40 obtains the banknote interval calculated by the calculating unit 20 and stores the banknote interval into a corresponding storage position of the storage area sequentially. The record and storage unit 40 also compares the banknote interval with a banknote interval with respect to a previous sensor, and if they are not consistent, determines there is an abnormal transmission, and the detection of banknotes is stopped.

The banknote detecting process is finished after all of the banknotes leave the banknote transmission passage and enter the banknote repository.

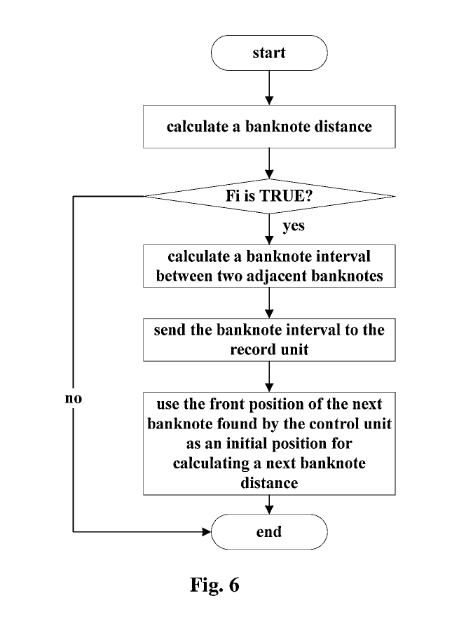

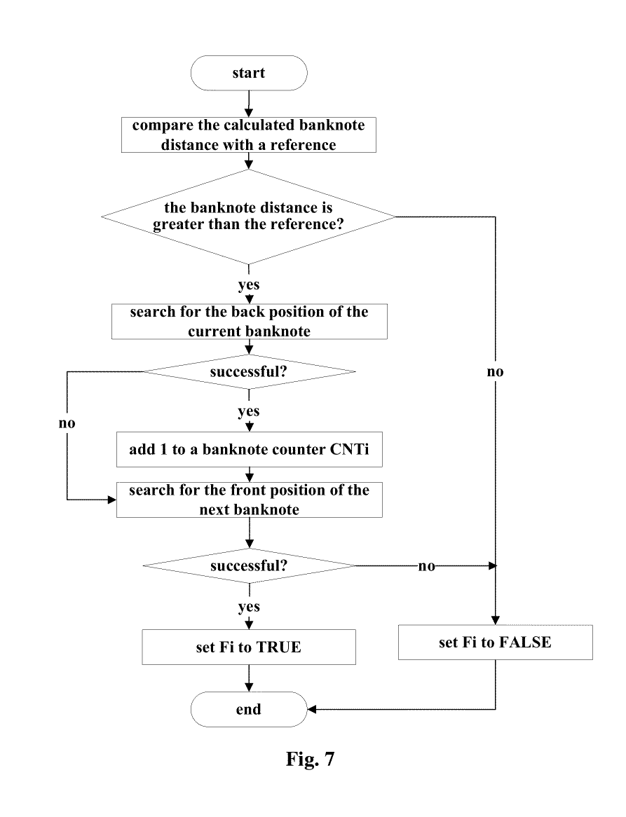

The device for detecting and counting banknote-like objects of the present invention will be described below by using a specific embodiment in conjunction with FIGS. 5 to 9.

For convenience of description, a banknote detection flag Fi corresponding to a i^{th} sensor is used to represent whether detection of a banknote is finished, where Fi is TRUE means that detection of the banknote is finished and Fi is FALSE means that detection of the banknote is not finished; and a banknote counter CNTi corresponding to the i^{th} sensor is used to represent the number of the banknotes passed through the i^{th} sensor. In addition, in the embodiment, a clock is used as a unit for calculating, the clock unit outputs a clock with a fixed cycle, and the sensor unit 10 outputs transmission states of banknotes passing through each of the sensors in accordance with the fixed clock cycle, and converts into binary values each representing presence or non-presence of a banknote, which can facilitate the calculation of the banknote distance and the banknote interval by the calculating unit 20.

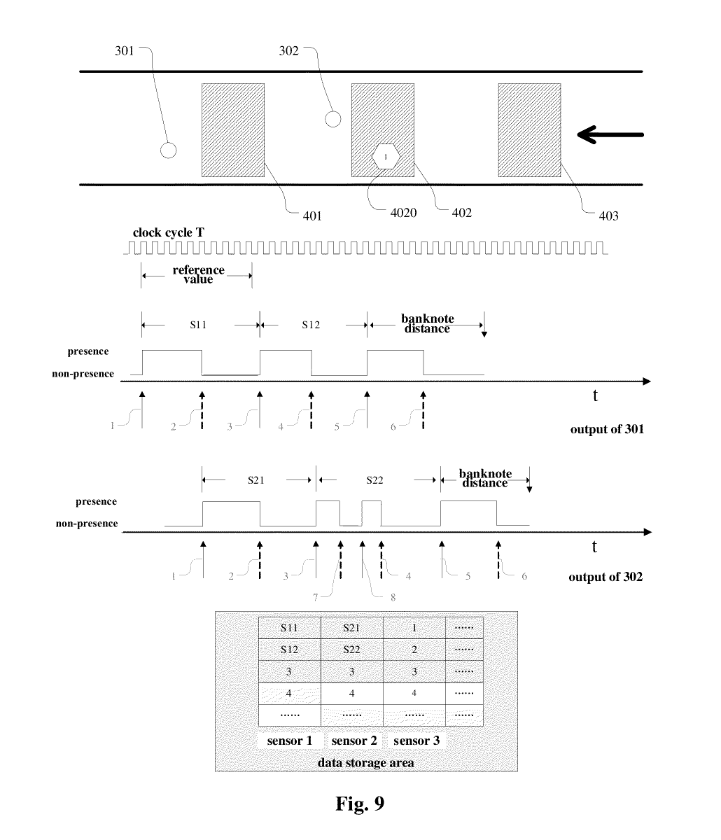

At the beginning of a service, data are firstly initialized, including setting all of the banknote detection flags Fi to FALSE, and resetting all of the banknote counters CNTi and banknote intervals in the storage area to 0. Then the banknote-pickup mechanism 41 separates gathered banknotes, and sends the banknotes one by one into the banknote transmission passage (the direction pointed by the arrow in FIG. 9). A first sensor 301 is located at a position where a banknote is firstly detected. Banknote 401 is the first banknote, banknote 402 is a banknote with a hole, and banknote 403 is the last banknote. When the banknotes sequentially pass through the sensors distributed on the transmission passage, each of the sensors will output corresponding signals and send the corresponding signals to the sensor unit 10. In accordance with the fixed clock cycle, the sensor unit 10 converts the signals outputted from the sensors into transmission states each representing presence or non-presence of a banknote, and provides the transmission states to the control unit 30 and the calculating unit 20 for processing.

When the banknote 401 passes through the first sensor 301, the calculating unit starts to calculate a distance between the first sensor 301 and the position 1 (that is, the front position of the banknote 401, it can be determined by the above-mentioned method) according to the transmission states outputted with respect to the first sensor 301 (as shown in FIG. 9). The control unit 30 compares the result calculated by the calculating unit 20 with a preset banknote interval reference S_{ref}. If the banknote distance is less than the banknote interval reference, the control unit 30 sets the detection flag F1 to FALSE. If the banknote distance is greater than the banknote interval reference, the control unit 30 searches the transmission states previously outputted with respect to the first sensor 301 for the back position of the banknote 401 (that is, a transition from presence to non-presence) and the front position of the banknote 402 (that is, a transition from non-presence to presence). As shown in FIG. 9, in the outputs of the first sensor 301, the position 2 pointed by an arrow meets the condition of the back position of the banknote 401, and the position 3 meets the condition of the front position of the banknote 402. When the control unit 30 finds the position 2, the banknote counter CNT1 corresponding to the first sensor 301 is added by 1; and when the control unit 30 finds the position 3 (representing that the banknote 402 reaches the first sensor), the detection flag F1 is set to TRUE. In a case that the banknote distance is greater than the reference but the control unit 30 does not find the front position of the next banknote meeting the conditions, the detection flag F1 is maintained to be FALSE.

When the detection flag F1 is set to TRUE, the calculating unit 20 firstly calculates a banknote interval S11 between the banknote 401 and the banknote 402 (that is, an interval between the position 3 and the position 1), and uses the position 3 found by the control unit 30 as an initial position for calculating the next banknote distance. The record and storage unit 40 stores the banknote interval S11 into its data storage area sequentially. Since the sensor 301 is the first sensor, the record and storage unit 40 does not judge whether there is an abnormal transmission (that is, does not compare the banknote interval) and returns a successful detection result directly. In a next clock cycle meeting the banknote interval reference, the calculating unit 20 continues to calculate a banknote distance between a current detecting position and the position 3 according to the transmission states outputted from the first sensor 301. In a similar way, the banknote interval S12 is calculated and stored sequentially in the data storage area of the record and storage unit, and the banknote counter CNT1 is added accumulatively.

When the last banknote 403 passes through the first sensor, the calculating unit calculates a banknote distance between the first sensor 301 and position 5 according to the transmission states outputted with respect to the first sensor 301. If the banknote distance is less than the reference, the control unit 30 sets the detection flag F1 to FALSE. If the banknote distance is greater than the reference, only the back position of the banknote 403 can be found by the control unit from the transmission states previously outputted with respect to the first sensor 301 since the banknote 403 is the last banknote, so only the counter CNT1 is added and the banknote interval is not calculated or stored.

In a similar way, when the banknote 401 passes through the second sensor 302, the calculating unit 20 starts to calculate a banknote distance between the second sensor 302 and position 1 (that is, the front position of the banknote 401, it can be determined by the above-mentioned method) according to the transmission states outputted with respect to the second sensor 302. If the banknote distance is less than the reference, the control unit sets the detection flag F2 to FALSE. If the banknote distance is greater than the reference, the control unit 30 searches the transmission states outputted previously with respect to the second sensor 302 for the back position of the banknote 401 (that is, a transition from presence to non-presence) and the front position of the next banknote 402. As shown in FIG. 9, in the outputs of the second sensor 302, the position 2 pointed by an arrow meets the condition of the back position of the banknote 401, and the position 3 meets the condition of the front position of the banknote 402. When the control unit 30 finds the position 2, the banknote counter CNT2 corresponding to the second sensor 302 is added by 1; and when the control unit finds the position 3 (representing the banknote 402 reaches the second sensor 302), the to detection flag F2 is set to TRUE. In a case that the banknote distance is greater than the reference but the control unit 30 does not find the front position of the next banknote meeting the conditions, the detection flag F2 is maintained to be FALSE.

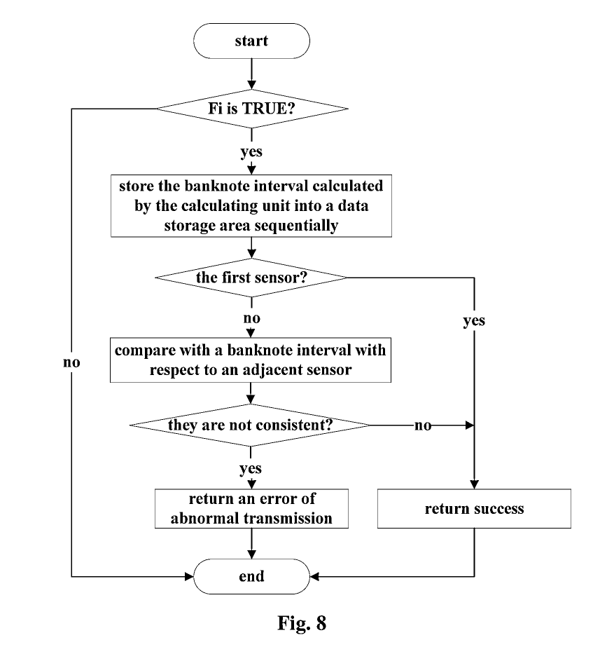

When the detection flag F2 is set to TRUE, the calculating unit 20 firstly calculates the banknote interval S21 between the banknote 401 and the banknote 402 (that is, the interval between the position 3 and the position 1), and uses the position 3 found by the control unit 30 as an initial position for calculating the next banknote distance. The record and storage unit stores the banknote interval S21 into its data storage area sequentially. Since the second sensor 302 is not the first sensor, the record and storage unit 40 compares S11 with S21, and returns an error of abnormal transmission if they are not consistent (as shown in FIG. 8) or returns a successful detection result otherwise. During the next clock cycle meeting the banknote interval reference, the calculating unit 20 calculates the banknote distance between a current detecting position and the position 3 according to the transmission states outputted with respect to the second sensor 302. Because the second sensor 302 will detect the hole 4020 of the banknote 402, two transitions from presence to non-presence (position 4 and position 7) and two transitions from non-presence to presence (position 5 and position 8) will be found by the control unit from the transmission states previously outputted with respect to the second sensor 302 in a case that the banknote distance is greater than the reference. However, according to the accumulative principle of the banknote counter of the present invention, the number of the transitions from presence to non-presence is not considered, and the counter CNT2 corresponding to the sensor is only added by 1 as long as at least one transmission state representing a transition from presence of a banknote to non-presence of a banknote is found. Meanwhile, since only the position 5 meets the locating conditions of the front position of the next banknote 403 according to the method described above for locating the front position of the banknote, the detection flag F2 is set to TRUE when the control unit 30 finds the position 5.

When the detection flag F2 is set to TRUE again, the calculating unit firstly calculates a banknote interval S22 between the banknote 402 and the banknote 403 (that is, the interval between the position 5 and the position 3), and uses the position 5 found by the to control unit 30 as an initial position for calculating the next banknote distance. The record and storage unit 40 stores the banknote interval S22 into its data storage area sequentially, and compares S12 with S22. Since S22 is the interval between the position 5 and position 3 rather than the interval between the position 8 and position 3, the record and storage unit 40 will not detect an error of abnormal transmission. Therefore, the interference caused by the hole 4020 of the banknote 402 is eliminated by the detection and calculation device of the present invention.

After the transmissions of all banknotes are finished, the values of both banknote counters CNT1 and CNT2 are 3, and no abnormal transmission error of banknotes occurs.

The present invention is not limited to the above embodiments, and can be implemented with various variations.

For example, although a light sensor is adopted to detect banknotes in the embodiments of the present invention, other types of sensors (such as a thickness detecting sensor or an image detecting sensor) may be applied to the device as long as their signals can be transformed to binary values which represent transmission states of a banknote. In addition, the detected objects of the present invention are not limited to banknotes, all of objects having regular shape and thin thickness will be suitable for the device.

In addition, variations in which only the objects to be compared in the present invention is changed (for example, the comparison of the banknote interval is changed to the comparison of the banknote length which is the distance between a front end and a back end of a banknote, or the banknote interval is defined as the distance between back ends of two adjacent banknotes), with the specific principles having no creative improvement with respect to the present invention, all fall within the scope of the present invention.

Furthermore, in the embodiment of the present invention, it is mainly described a device for eliminating the interference brought by a banknote with a hole, but the interference of the sensor signal itself or the interference due to problems of the banknote transmission (for example, a back end of a banknote is connected with a front end of a banknote, or the banknote interval is too small) are all suitable for the device.

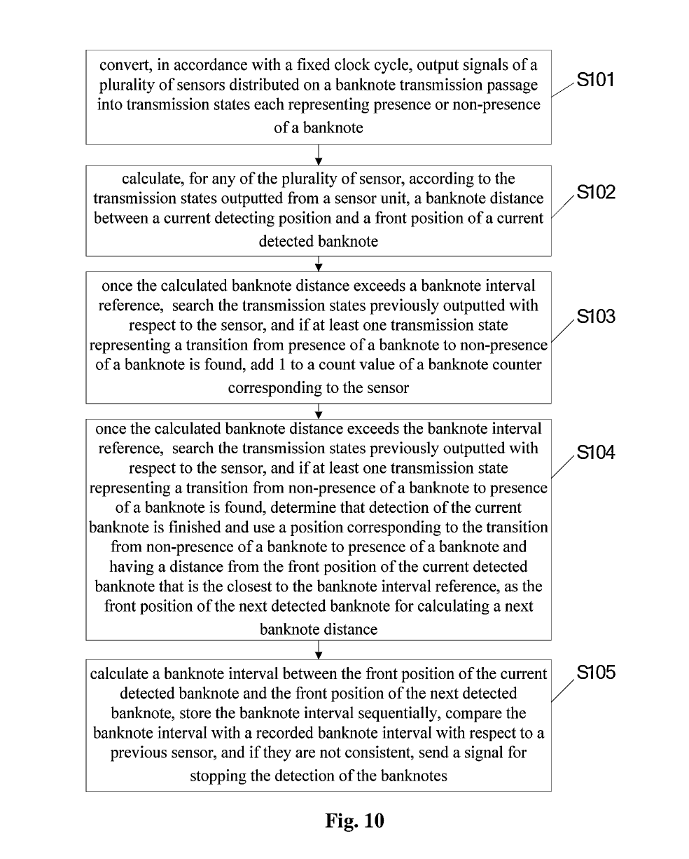

FIG. 10 is a flowchart of a method for detecting and counting banknote-like to objects according to the present invention. The method includes steps as following:

S101, converting output signals of a plurality of sensors distributed on a banknote transmission passage into transmission states each representing presence or non-presence of a banknote, in accordance with a fixed clock cycle.

At the beginning of a service, a banknote-pickup mechanism firstly separates gathered banknotes, and sends the banknotes into a banknote transmission passage one by one. When the banknotes sequentially pass through the sensors distributed on the transmission passage, each of the sensors will output corresponding signals. The corresponding signals outputted from each of the sensors are converted into transmission states each representing presence or non-presence of a banknote in accordance with a fixed clock cycle provided by a clock unit, for subsequent processing.

S102, calculating, for any of the plurality of sensors, according to the transmission states output from a sensor unit, a banknote distance between a current detecting position and a front position of a current detected banknote.

S103, once the calculated banknote distance exceeds a banknote interval reference, searching the transmission states previously outputted with respect to the sensor, and if at least one transmission state representing a transition from presence of a banknote to non-presence of a banknote is found, adding 1 to a count value of a banknote counter corresponding to the sensor.

In this step, the calculated banknote distance is compared with a preset banknote interval reference. Once the banknote distance exceeds the banknote interval reference, a control unit will search the transmission states previously outputted with respect to the sensor for a back position of the current banknote (that is, a transition from presence to non-presence), and add 1 to a count value of a banknote counter corresponding to the sensor if at least one transmission state representing a transition from presence of a banknote to non-presence of a banknote is found. The banknote interval reference is determined by S_{ref}=kπD, where S_{ref} denotes the banknote interval reference; k denotes a transmission coefficient indicating a ratio of a transmission rate to a pickup rate of a banknote in the passage; and πD denotes a perimeter of a banknote-pickup wheel.

S104, once the calculated banknote distance exceeds the banknote interval reference, searching the transmission states previously outputted with respect to the sensor, and if at least one transmission state representing a transition from non-presence of a banknote to presence of a banknote is found, determining that detection of the current banknote is finished and using a detecting position representing the transition from non-presence of a banknote to presence of a banknote and having a distance from the front position of the current detected banknote that is the closest to the banknote interval reference, as the front position of the next detected banknote for calculating the next banknote distance.

In this step, once the calculated banknote distance exceeds the banknote interval reference, the searching for the front position of the next banknote (that is, a transition from non-presence to presence) is performed, and if at least one transmission state representing a transition from non-presence of a banknote to presence of a banknote is found, it is determined that detection of the current banknote is finished, and a detecting position representing the transition from non-presence of a banknote to presence of a banknote and having a distance from the front position of the current detected banknote that is the closest to the banknote interval reference, is used as the front position of the next detected banknote and used as an initial position for calculating the next banknote distance.

S105, calculating a banknote interval between the front position of the current detected banknote and the front position of the next detected banknote, storing the banknote interval sequentially, comparing the banknote interval with a recorded banknote interval with respect to a previous sensor, and if they are not consistent, sending a signal for stopping the detection of banknotes.

If it is determined that detection of the current banknote passing through the sensor is finished, the banknote interval between the front position of the current detected banknote and the front position of the next detected banknote is calculated and stored sequentially. Meanwhile, the banknote interval is compared with a recorded banknote interval with respect to a previous sensor, and if they are not consistent, it is determined that the transmission is abnormal and the detection of the banknotes is stopped.

Finally, the banknote detection process is finished after all of the banknotes leave the banknote transmission passage and enter the banknote repository.

The above are only preferred embodiments of the present invention, and it is to be noted that modifications and variations can be made by those skilled in the art without departing from principles of the invention, and these modifications and variations also fall within the protection scope of the invention.

1. A device for detecting and counting banknote-like objects, comprising:
a sensor unit, adapted to convert output signals of a plurality of sensors distributed on a banknote transmission passage into transmission states each representing presence or non-presence of a banknote, wherein each of the plurality of sensors corresponds to a banknote counter;
a calculating unit, adapted to calculate, for any of the plurality of sensors, a banknote distance between a current detecting position and a front position of a current detected to banknote according to the transmission states outputted from the sensor unit; and
a control unit, adapted to, once the banknote distance calculated by the calculating unit exceeds a banknote interval reference, search the transmission states previously outputted with respect to the sensor, and
if at least one transmission state representing a transition from presence of a banknote to non-presence of a banknote is found, add 1 to a count value of a banknote counter corresponding to the sensor;
if at least one transmission state representing a transition from non-presence of a banknote to presence of a banknote is found, determine that detection of the current banknote is finished and send a detecting position representing the transition from non-presence of a banknote to presence of a banknote and having a distance from the front position of the current detected banknote that is the closest to the banknote interval reference, as a front position of a next detected banknote, to the calculating unit, so that the calculating unit uses the front position of the next detected banknote as an initial position for calculating a next banknote distance.

2. The device for detecting and counting banknote-like objects according to claim 1, further comprising:
a record and storage unit, adapted to obtain a banknote interval, between the front position of the current detected banknote and the front position of the next detected banknote, calculated by the calculating unit on receipt of the front position of the next detected banknote, store the banknote interval sequentially, compare the banknote interval with a recorded banknote interval with respect to a previous sensor, and if they are not consistent, send a signal for stopping detection of the banknotes.

3. The device for detecting and counting banknote-like objects according to claim 1, wherein the banknote interval reference is determined by:
S_{ref}=kπD:
wherein, S_{ref} denotes the banknote interval reference; k denotes a transmission coefficient indicating a ratio of a transmission rate to a pickup rate of a banknote in the to passage; and πD denotes a perimeter of a banknote-pickup wheel.

4. The device for detecting and counting banknote-like objects according to claim 3, further comprising a clock unit, wherein the sensor unit converts the output signals of the plurality of sensors into the transmission states each representing presence or non-presence of a banknote in accordance with a fixed clock cycle provided by the clock unit.

5. The device for detecting and counting banknote-like objects according to claim 1, wherein for any of the plurality of sensors, a position, which corresponds to a transmission state representing a transition from non-presence of a banknote to presence of a banknote outputted with respect to the sensor for the first time, is determined as a front position of a first detected banknote.

6. A method for detecting and counting banknote-like objects, comprising steps of:
A1, converting output signals of a plurality of sensors distributed on a banknote transmission passage into transmission states each representing presence or non-presence of a banknote;
A2, calculating, for any of the plurality of sensors, a banknote distance between a current detecting position and a front position of a current detected banknote according to the transmission states outputted from a sensor unit;
A3, once the calculated banknote distance exceeds a banknote interval reference, searching the transmission states previously outputted with respect to the sensor, and if at least one transmission state representing a transition from presence of a banknote to non-presence of a banknote is found, adding 1 to a count value of a banknote counter corresponding to the sensor; and
A4, once the calculated banknote distance exceeds the banknote interval reference, searching the transmission states previously outputted with respect to the sensor, and if at least one transmission state representing a transition from non-presence of a banknote to presence of a banknote is found, determining that detection of the current banknote is to finished and using a detecting position representing the transition from non-presence of a banknote to presence of a banknote and having a distance from the front position of the current detected banknote that is the closest to the banknote interval reference, as a front position of a next detected banknote for calculating a next banknote distance.

7. The method for detecting and counting banknote-like objects according to claim 6, further comprising a step of:
A5, calculating a banknote interval between the front position of the current detected banknote and the front position of the next detected banknote, storing the banknote interval sequentially, comparing the banknote interval with a recorded banknote interval with respect to a previous sensor, and if they are not consistent, sending a signal for stopping detection of the banknotes.

8. The method for detecting and counting banknote-like objects according to claim 6, wherein the banknote interval reference is determined by:
S_{ref}=kπD;
wherein, S^{ref} denotes the banknote interval reference; k denotes a transmission coefficient indicating a ratio of a transmission rate to a pickup rate of a banknote in the passage; and πD denotes a perimeter of a banknote-pickup wheel.

9. The method for detecting and counting banknote-like objects according to claim 8, wherein the step A2 comprises converting the output signals of the plurality of sensors distributed on the banknote transmission passage into the transmission states each representing presence or non-presence of a banknote in accordance with a fixed clock cycle.

10. The method for detecting and counting banknote-like objects according to claim 6, wherein for any of the plurality of sensors, a position, which corresponds to a transmission state representing a transition from non-presence of a banknote to presence of a banknote outputted with respect to the sensor for the first time, is determined as a front position of a first detected banknote.
